(19) United States
(12) Patent Application Publication
(10) Pub. No.: US 2012/0249927 A1
(43) Pub. Date: Oct. 4, 2012

(54) LIQUID CRYSTAL DISPLAY DEVICE

(75) Inventors: Atsuo NAKAGAWA, Mobara (JP); Eiji Oohira, Mobara (JP)

(73) Assignee: Hitachi Displays, Ltd.

(21) Appl. No.: 13/424,520

(22) Filed: Mar. 20, 2012

(30) Foreign Application Priority Data
Mar. 29, 2011 (JP) 2011-071411

(51) Int. Cl. G02F 1/13357

(52) U.S. Cl. 349/65

(57) ABSTRACT

A liquid crystal display device includes: a liquid crystal display panel having a display surface and a rear surface; a light guide plate arranged so as to avoid a position below an edge of the liquid crystal display panel on the side of the rear surface; a flexible wiring board having a portion arranged below the edge of the liquid crystal display panel with a gap disposed between the portion and the edge; a light source mounted, for introducing light, on a surface of the flexible wiring board on the side of the liquid crystal display panel at a position below the edge of the liquid crystal display panel; and a reinforcing plate located next to the light source on the opposite side to the light guide plate and attached to the surface of the flexible wiring board where the light source is mounted.

### CROSS-REFERENCE TO RELATED APPLICATION

The present application claims priority from Japanese application JP2011-071411 filed on Mar. 29, 2011, the contents of which are hereby incorporated by reference into this application.

### BACKGROUND OF THE INVENTION

1. Field of the Invention

The present invention relates to a liquid crystal display device.

2. Description of the Related Art

As liquid crystal display devices including a backlight, an example of using an FPC (Flexible Printed Circuit) mounting LEDs (Light Emitting Diodes) has been known. In an example shown in JP 2009-216753 A, an FPC is bent so as to extend from a liquid crystal display panel to the side of a back surface of a light guide plate of a backlight. LEDs mounted on the FPC are arranged so as to face an end face of the light guide plate.

Since the base material of the FPC is formed of a thin material so that the FPC is easily bent, wiring is susceptible to damage when bending stress is generated. Therefore, it is conceivable to attach a reinforcing plate to the FPC. However, when the reinforcing plate is attached, the thickness as the FPC is increased, making it difficult to meet the demand for a reduction in thickness of devices in recent years.

### SUMMARY OF THE INVENTION

An object of the invention is to reduce damage to wiring while meeting the demand for a reduction in thickness.

(1) A liquid crystal display device according to the invention includes: a liquid crystal display panel having a display surface and a rear surface opposite to the display surface; a light guide plate arranged so as to avoid a position below an edge of the liquid crystal display panel on the side of the rear surface of the liquid crystal display panel; a flexible wiring board having a portion arranged below the edge of the liquid crystal display panel with a gap disposed between the portion and the edge; a light source mounted, for introducing light to the light guide plate, on a surface of the flexible wiring board on the side of the liquid crystal display panel at a position below the edge of the liquid crystal display panel; and a reinforcing plate located next to the light source on the opposite side to the light guide plate and attached to the surface of the flexible wiring board where the light source is mounted. According to the invention, the reinforcing plate is attached to the surface of the flexible wiring board where the light source is mounted, so that the reinforcing plate can be contained inside the flexible wiring board to avoid an increase in thickness. Therefore, it is possible to reduce damage to the wiring while meeting the demand for a reduction in thickness.

(2) In the liquid crystal display device according to (1), the flexible wiring board may have a portion which is longer in a second direction than in a first direction between the light source and the reinforcing plate, the second direction being perpendicular to the first direction, and a plurality of the light sources may be mounted to be aligned in the second direction in the portion which is longer in the second direction.

(3) In the liquid crystal display device according to (2), the reinforcing plate may extend along the second direction, and the plurality of the light sources may be arranged to be shifted from the reinforcing plate in the first direction within a range of the length of the reinforcing plate in the second direction.

(4) In the liquid crystal display device according to (3), the reinforcing plate may be arranged in a shape in which the reinforcing plate extends between the light sources next to each other.

(5) In the liquid crystal display device according to any one of (1) to (4), the flexible wiring board may have a base material, wiring formed on the base material on the side where the light source is mounted, and a cover covering the wiring, the wiring may have a portion exposed from the cover, and the light source may be joined so as to be electrically connected to the portion of the wiring exposed from the cover.

(6) In the liquid crystal display device according to any one of (1) to (5), the flexible wiring board may include a joint portion with the liquid crystal display panel and a connection portion extending from the joint portion to the reinforcing plate and the mounting portion of the light source, and the connection portion may bend so that the exterior thereof is convex at the side of the liquid crystal display panel.

(7) In the liquid crystal display device according to any one of (1) to (6), the liquid crystal display device may further include a reflective sheet overlapping with the light guide plate on the opposite side to the liquid crystal display panel, the flexible wiring board may be arranged next to the reflective sheet while avoiding an overlap with the reflective sheet, and the flexible wiring board may be arranged so as not to project below a surface of the reflective sheet on the opposite side to the light guide plate.

(8) In the liquid crystal display device according to any one of (1) to (7), the liquid crystal display device may further include a frame supporting the edge of the liquid crystal display panel on the side of the rear surface and arranged so as to overlap with the reinforcing plate on the side of the liquid crystal display panel.

(9) In the liquid crystal display device according to (8), the frame may have a recess or cutout at a region facing the reinforcing plate.

(10) In the liquid crystal display device according to (8) or (9), the reinforcing plate may be attached to the frame.

### BRIEF DESCRIPTION OF THE DRAWINGS

FIG. 1 is a plan view showing a liquid crystal display device according to an embodiment of the invention.

FIG. 2 shows a back surface of the liquid crystal display device shown in FIG. 1.

FIG. 3 is a cross-sectional view of the liquid crystal display device shown in FIG. 1 taken along line III-III.

FIG. 4 shows the liquid crystal display device shown in FIG. 2 with a flexible wiring board unrolled.

FIG. 5 is an enlarged cross-sectional view of the liquid crystal display device shown in FIG. 4 taken along line V-V.

FIG. 6 shows a modified example of a reinforcing plate.

### DETAILED DESCRIPTION OF THE INVENTION

Hereinafter, an embodiment of the invention will be described with reference to the drawings.

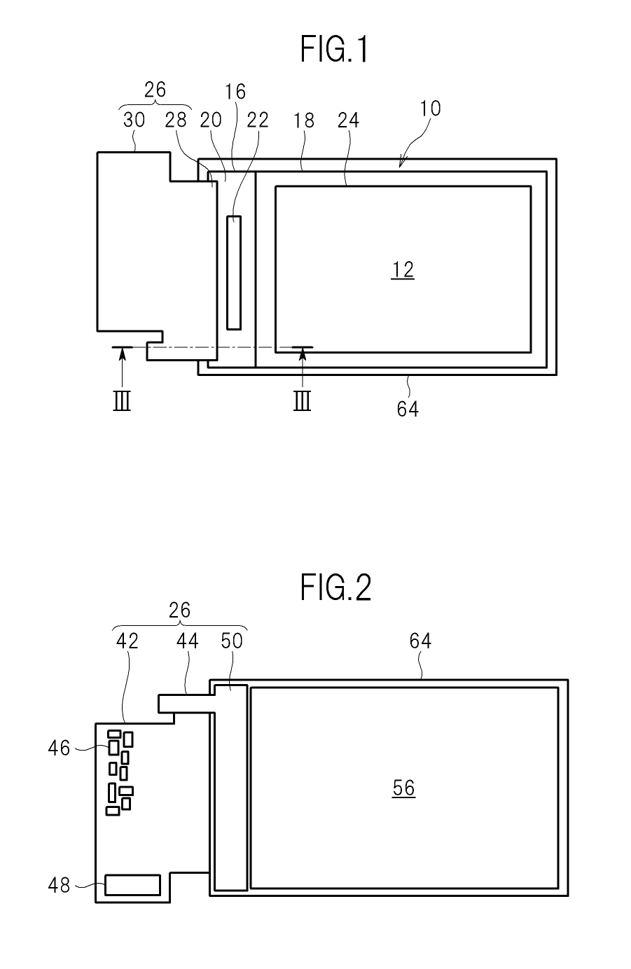

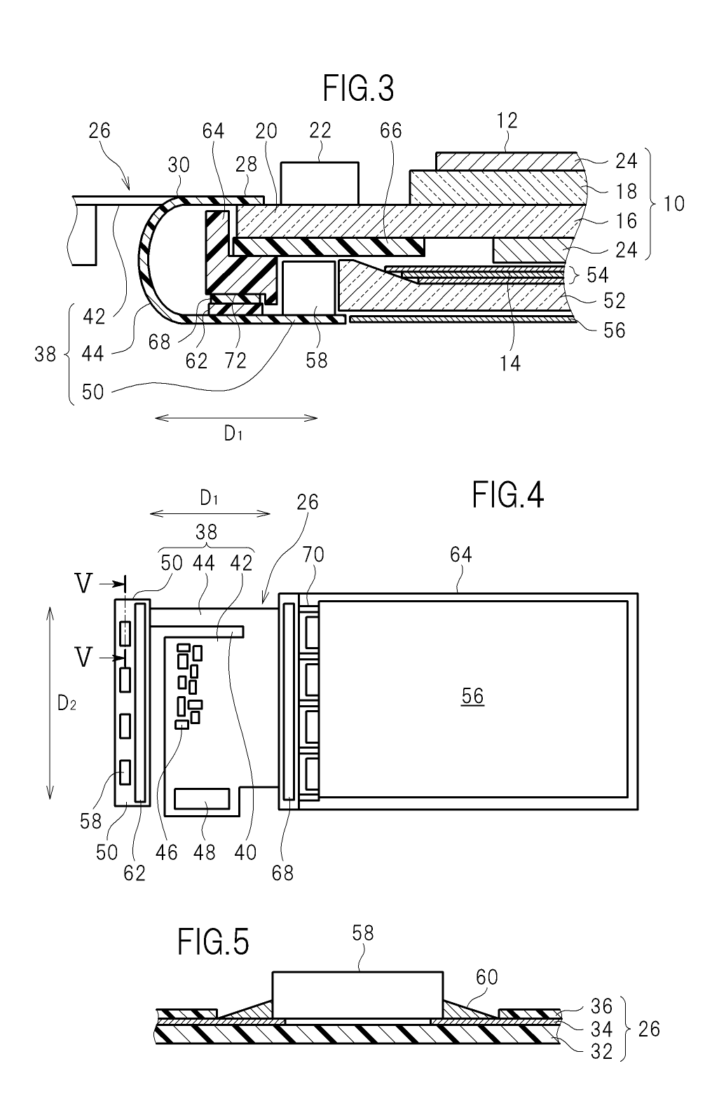

FIG. 1 is a plan view showing a liquid crystal display device according to the embodiment of the invention. FIG. 2 shows a back surface of the liquid crystal display device shown in FIG. 1. FIG. 3 is a cross-sectional view of the liquid crystal display device shown in FIG. 1 taken along line III-III.

The liquid crystal display device has a liquid crystal display panel 10. The liquid crystal display panel 10 has a display surface 12 for displaying an image and a rear surface 14 (refer to FIG. 3) opposite to the display surface 12. The liquid crystal display panel 10 has a pair of substrates 16 and 18 (both are glass substrates) and liquid crystal (not shown) interposed between the substrates. The substrate 16 is a TFT (Thin Film Transistor) substrate (or an array substrate) including thin film transistors, pixel electrodes, wiring, and the like, while the substrate 18 is a color filter substrate. The driving system of the liquid crystal display panel 10 may be any of an IPS (In-Plane Switching) system, TN (Twisted Nematic) system, VA (Vertical Alignment) system, or the like, and electrodes and wiring according to the system are formed.

The substrate 16 of the liquid crystal display panel 10 has a projecting portion 20 projecting from the other substrate. An integrated circuit chip 22 incorporating a driver circuit for driving the liquid crystal is mounted on the liquid crystal display panel 10 (specifically, the projecting portion 20). A polarizer 24 is attached to each of the pair of substrates 16 and 18 of the liquid crystal display panel 10.

A flexible wiring board 26 is fixed to the liquid crystal display panel 10 (specifically, the projecting portion 20). As shown in FIG. 3, the flexible wiring board 26 bends to extend from above the display surface 12 of the liquid crystal display panel 10 to below the rear surface 14. The flexible wiring board 26 has a portion arranged below an edge of the liquid crystal display panel 10 with a gap disposed between the portion and the edge. The flexible wiring board 26 includes a joint portion 28 with the liquid crystal display panel 10 and a connection portion 30 extending from the joint portion 28. The connection portion 30 is a portion of the flexible wiring board 26 other than the joint portion 28. The connection portion 30 bends so that the exterior thereof is convex at the side of the liquid crystal display panel 10.

FIG. 4 shows the liquid crystal display device shown in FIG. 2 with the flexible wiring board 26 unrolled. FIG. 5 is an enlarged cross-sectional view of the liquid crystal display device shown in FIG. 4 taken along line V-V. The flexible wiring board 26 has a base material 32 and wiring 34 formed on the base material 32. The wiring 34 is covered with a cover 36 (for example, solder resist). The wiring 34 has a portion exposed from the cover 36. The wiring 34 is electrically connected to the liquid crystal display panel 10.

As shown in FIG. 4, the flexible wiring board 26 has a main body 38 connected to the liquid crystal display panel 10. The main body 38 has a first portion 42 on one side and a second portion 44 on the other side via a slit 40 formed in a direction away from the liquid crystal display panel 10. On the first portion 42, electronic components 46, such as resistors and capacitors, and a connector 48 are mounted.

The flexible wiring board 26 (the main body 38) has a third portion 50 which is connected to the second portion 44 and longer in a second direction D₂ than in a first direction D₁. The first direction D₁ is a direction of the flexible wiring board 26 extending from the liquid crystal display panel 10, or a direction of the flexible wiring board 26 extending from the bending portion thereof to below the liquid crystal display panel 10. The second direction D₂ is a direction perpendicular to the first direction D₁.

The liquid crystal display device has a light guide plate 52. A surface of the light guide plate 52 faces the rear surface 14 of the liquid crystal display panel 10. The light guide plate 52 is arranged so as to avoid a position below the edge of the liquid crystal display panel 10 on the side of the rear surface 14 of the liquid crystal display panel 10.

A group of optical sheets 54 are arranged between the liquid crystal display panel 10 and the light guide plate 52. The group of optical sheets 54 includes a diffusion sheet and a prism sheet. Moreover, a reflective sheet 56 is arranged below the light guide plate 52 (on the opposite side to the group of optical sheets 54).

The liquid crystal display device has light sources 58 (for example, light emitting diodes) for introducing light to the light guide plate 52. The light guide plate 52 converts light of the light source 58 as a point light source to a surface light source and emits the light to the liquid crystal display panel 10. The light source 58 faces an end face of the light guide plate 52.

The light sources 58 are mounted on a surface of the flexible wiring board 26 on the side of the liquid crystal display panel 10 at a position below the edge portion of the liquid crystal display panel 10. As shown in FIG. 5, the light source 58 is joined so as to be electrically connected to the portion of the wiring 34 exposed from the cover 36 formed in the flexible wiring board 26. The electrical connection and physical joint of the light source are made with solder 60. The plurality of light sources 58 are mounted to be aligned in the second direction D₂ in the third portion 50 of the flexible wiring board 26, the third portion 50 being long in the second direction D₂, (refer to FIG. 4).

To the flexible wiring board 26 (specifically, the third portion 50 thereof), a reinforcing plate 62 is attached. The reinforcing plate 62 is attached to the surface of the flexible wiring board 26 where the light sources 58 are mounted. The reinforcing plate 62 is located next to the light sources 58 on the opposite side to the light guide plate 52. The reinforcing plate 62 extends along the second direction D₂ (refer to FIG. 4). Moreover, the reinforcing plate 62 is formed along the second direction D₂ without interruption, and a side thereof extending along the second direction D₂ forms a straight line or curved line without projections or depressions.

The plurality of light sources 58 are arranged to be shifted from the reinforcing plate 62 in the first direction D₁ within a range of the length of the reinforcing plate 62 in the second direction D₂ (refer to FIG. 4). The first direction D₁ is also a direction between the light source 58 and the reinforcing plate 62. The reinforcing plate 62 may be formed of resin or metal, or may be formed of the same material as that of the base material 32 of the flexible wiring board 26.

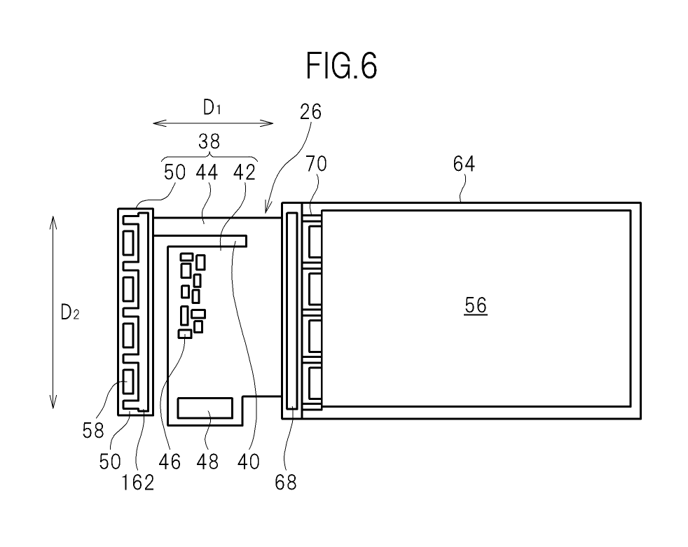

A reinforcing plate 162 shown in FIG. 6 as a modified example has a shape in which the reinforcing plate extends between the light sources 58 next to each other. As shown in FIG. 4, however, the reinforcing plate 62 having a shape in which the reinforcing plate is formed so as to avoid a position between the light sources 58 next to each other is advantageous in printing solder paste. That is, when solder paste is disposed on the wiring 34 by screen printing for joining the light sources 58, step portions due to the presence or absence of the reinforcing plate 62 are not formed in the second direction D₂ if the reinforcing plate 62 has the shape shown in FIG. 4, and therefore, a squeegee can be moved smoothly.

As shown in FIG. 3, the reflective sheet 56 is arranged so as to overlap with the light guide plate 52 on the opposite side to the liquid crystal display panel 10. The flexible wiring board 26 is arranged next to the reflective sheet 56 while avoiding an overlap with the reflective sheet 56.

The liquid crystal display device has a frame 64 made of, for example, resin. The liquid crystal display panel 10 is fixed to the frame 64. Specifically, the frame 64 has a frame shape, and the liquid crystal display panel 10 is attached to one surface of the frame so as to cover the inner space of the frame. For the attachment, a light-shielding double-faced tape 66 (refer to FIG. 3) is used. The frame 64 supports the edges of the liquid crystal display panel 10 on the side of the rear surface 14. The frame 64 is arranged so as to overlap with the reinforcing plate 62 on the side of the liquid crystal display panel 10. The reinforcing plate 62 is attached to the frame 64. For the attachment, a double-faced tape 68 is used. Moreover, another double-faced tape 70 (refer to FIG. 4) attaches the third portion 50 (portion being long in the second direction D₂) of the flexible wiring board 26 where the light sources 58 are mounted to the frame 64 at positions avoiding the light sources 58.

As shown in FIG. 3, the frame 64 has a recess or cutout 72 at a region facing the reinforcing plate 62. With the recess or cutout 72, the thickness of the reinforcing plate 62 is absorbed, and the downward bulging of the flexible wiring board 26 is prevented.

The flexible wiring board 26 does not project below a surface of the reflective sheet 56 on the opposite side to the light guide plate 52.

According to the embodiment, the reinforcing plate 62 is attached to the surface of the flexible wiring board 26 where the light sources 58 are mounted, so that the reinforcing plate 62 can be contained inside the flexible wiring board to avoid an increase in thickness. With this configuration, it is possible to reduce damage to the wiring 34 while meeting the demand for a reduction in thickness.

The invention is not limited to the embodiment described above, but various kinds of modifications are possible. For example, the configuration described in the embodiment can be replaced by substantially the same configuration, a configuration providing the same operation and advantage, and a configuration capable of achieving the same object.

What is claimed is:

1. A liquid crystal display device comprising:
a liquid crystal display panel having a display surface and a rear surface opposite to the display surface;
a light guide plate arranged so as to avoid a position below an edge of the liquid crystal display panel on the side of the rear surface of the liquid crystal display panel;
a flexible wiring board having a portion arranged below the edge of the liquid crystal display panel with a gap disposed between the portion and the edge;
a light source mounted, for introducing light to the light guide plate, on a surface of the flexible wiring board on the side of the liquid crystal display panel at a position below the edge of the liquid crystal display panel; and
a reinforcing plate located next to the light source on the opposite side to the light guide plate and attached to the surface of the flexible wiring board where the light source is mounted.

2. The liquid crystal display device according to claim 1, wherein
the flexible wiring board has a portion which is longer in a second direction than in a first direction between the light source and the reinforcing plate, the second direction being perpendicular to the first direction, and
a plurality of the light sources are mounted to be aligned in the second direction in the portion which is longer in the second direction.

3. The liquid crystal display device according to claim 2, wherein
the reinforcing plate extends along the second direction, and
the plurality of the light sources are arranged to be shifted from the reinforcing plate in the first direction within a range of the length of the reinforcing plate in the second direction.

4. The liquid crystal display device according to claim 3, wherein
the reinforcing plate is arranged in a shape in which the reinforcing plate extends between the light sources next to each other.

5. The liquid crystal display device according to claim 1, wherein
the flexible wiring board has a base material, wiring formed on the base material on the side where the light source is mounted, and a cover covering the wiring,
the wiring has a portion exposed from the cover, and the light source is joined so as to be electrically connected to the portion of the wiring exposed from the cover.

6. The liquid crystal display device according to claim 1, wherein
the flexible wiring board includes a joint portion with the liquid crystal display panel and a connection portion extending from the joint portion to the reinforcing plate and the mounting portion of the light source, and
the connection portion bends so that the exterior thereof is convex at the side of the liquid crystal display panel.

7. The liquid crystal display device according to claim 1, further comprising a reflective sheet overlapping with the light guide plate on the opposite side to the liquid crystal display panel, wherein
the flexible wiring board is arranged next to the reflective sheet while avoiding an overlap with the reflective sheet, and
the flexible wiring board is arranged so as not to project below a surface of the reflective sheet on the opposite side to the light guide plate.

8. The liquid crystal display device according to claim 1, further comprising a frame supporting the edge of the liquid crystal display panel on the side of the rear surface and arranged so as to overlap with the reinforcing plate on the side of the liquid crystal display panel.

9. The liquid crystal display device according to claim 8, wherein
the frame has a recess or cutout at a region facing the reinforcing plate.

10. The liquid crystal display device according to claim 8, wherein
the reinforcing plate is attached to the frame.
